(19) United States
(12) Patent Application Publication
(10) Pub. No.: US 2005/0205111 A1
(43) Pub. Date: Sep. 22, 2005

(54) Method and apparatus for processing a microfeature workpiece with multiple fluid streams

(76) Inventors: Thomas L. Ritzdorf, Bigfork, MT (US); Dakin Fulton, Barbizon (FR); Robert W. Batz JR., Kalispell, MT (US); Kevin Witt, Bigfork, MT (US); Kyle M. Hanson, Kalispell, MT (US)

Correspondence Address: PERKINS COIE LLP;PATENT-SEA, P.O. BOX 1247, SEATTLE, WA, 98111-1247, US

(21) Appl. No.: 11/020,018

(22) Filed: Dec. 20, 2004

Related U.S. Application Data
(63) Continuation-in-part of application No. 09/836,844, filed on Apr. 17, 2001, now Pat. No. 6,854,473.
Application No. 09/836,844 is a continuation of application No. 09/416,235, filed on Oct. 12, 1999, now abandoned.

(51) Int. Cl. B08B 3/02

(52) U.S. Cl. 134/10; 134/56 R; 134/25.4; 134/26; 134/902; 134/24; 134/94.1; 134/95.1

(57) ABSTRACT

Methods and apparatuses for processing microfeature workpieces are disclosed herein. In one embodiment, a workpiece support carries a workpiece in a processing volume of a processing chamber. A first fluid delivery device directs an unsupported stream of a first fluid into the processing volume. A second fluid delivery device directs an unsupported stream of a second fluid into the processing volume. A first fluid collector receives at least a portion of the first fluid, and a second fluid collector receives at least a portion of the second fluid. Accordingly, embodiments of the apparatus support the use of multiple fluids in a single processing volume to control, restrict, and/or eliminate mixing between the two fluids while reducing and/or eliminating the need for purging and/or rinsing portions of the apparatus. The rotation rate and/or position of the workpiece can also be controlled to control the manner in which the fluids are collected.

### CROSS-REFERENCE TO RELATED APPLICATION

The present application is a continuation-in-part of pending U.S. application Ser. No. 09/836,844, filed Apr. 17, 2001 and incorporated herein in its entirety by reference, which is a continuation of U.S. application Ser. No. 09/416,235, filed Oct. 12, 1999, now abandoned.

### BACKGROUND

Microelectronic devices, such as semiconductor devices, MEMS devices, microelectronic sensors and magnetic recording heads are generally fabricated on, and/or in, microelectronic workpieces using several different types of machines (“tools”). Many such processing machines have a single processing station that performs one or more procedures on the workpieces. Other processing machines have a plurality of processing stations that perform a series of different procedures on individual workpieces or batches of workpieces. In a typical fabrication process, one or more layers of conductive material are formed on the workpieces during deposition stages. The workpieces are then typically subjected to etching and/or polishing procedures (i.e., planarization) to remove a portion of the deposited conductive layers for forming electrically isolated contacts and/or conductive lines.

Plating tools that plate metals or other materials on the workpieces are becoming an increasingly useful type of processing machine. Electroplating and electroless plating techniques can be used to deposit copper, solder, permalloy, gold, silver, platinum and other metals onto workpieces for forming blanket layers or patterned layers. A typical copper plating process involves depositing a copper seed layer onto the surface of the workpiece using chemical vapor deposition (CVD), physical vapor deposition (PVD), electroless plating processes, or other suitable methods. After forming the seed layer, a blanket layer or patterned layer of copper is plated onto the workpiece by applying an appropriate electrical potential between the seed layer and an anode in the presence of an electroprocessing solution. The workpiece is then cleaned, etched and/or annealed in subsequent procedures before transferring the workpiece to another processing machine.

In some conventional arrangements, fluid is applied to the workpiece in the form of a spray that issues from one or more spray nozzles. For example, electroless deposition process fluids and etchants are applied to the workpiece in this manner. Because the chemical processes carried out by these fluids are time-critical (and in some cases, temperature-critical), it is important to carefully control the period of time during which the process fluids are in contact with the workpiece, and/or the process temperature. One approach to achieving this end is to quickly move the workpiece from a processing station to a rinsing station after the chemical process is complete. However, this transfer process may not be rapid enough to quickly halt the chemical processes active on the face of the workpiece. Accordingly, another approach to achieving this end is to rinse the workpiece immediately upon completing a chemical process by directing a spray of rinse fluid (e.g., deionized water) through the process fluid spray nozzles at the process station using an in-situ rinse process. The foregoing arrangement has several drawbacks. For example, the rinse fluid dilutes any process fluid remaining in the process vessel, rendering the residual process fluid in the vessel unsuitable for re-use. Furthermore, the chemical process that should be halted by the rinse fluid may continue for as long as it takes the rinse fluid to purge the spray nozzles, which may result in over-processing the workpiece. Still further, relatively large quantities of rinse fluid may be required to rinse not only the workpiece, but also the interior of the vessel, to prevent cross-contamination of the fluids.

Another drawback with some conventional arrangements is that they may not adequately control the amount of processing solution that is disposed of. These arrangements may accordingly waste solution and therefore reduce the overall efficiency of the process. Furthermore, conventional arrangements may mix different processing solutions in costly ways. For example, if acids or other substances that require careful waste handling techniques are allowed to mix with relatively benign solutions (e.g., rinse water), then the entire volume of both rinse water and acid must be disposed of using carefully controlled (and therefore expensive) procedures. Conversely, while small amounts of rinse water may permissibly mix with acids or other substances, such mixing will unacceptably dilute the acid if it is not controlled.

### SUMMARY

The present invention is directed toward methods and apparatuses for executing multiple processes on a microfeature workpiece at a single processing station. By performing multiple functions at a single processing station, the number of stations and therefore the volume occupied by the stations are reduced. Furthermore, in some embodiments, the volume of the chemicals required to perform the processes is also reduced. For example, in one embodiment, a processing chamber includes two fluid delivery devices: a first fluid delivery device positioned to direct an unsupported stream of a first fluid toward the microfeature workpiece, and a second fluid delivery device positioned to direct an unsupported stream of a second fluid toward the microfeature workpiece. Accordingly, the first fluid delivery device need not be purged of the first fluid before the second fluid is introduced into the processing chamber. Instead, the second fluid can be introduced through the (separate) second fluid delivery device. Separate fluid collectors collect the first fluid and the second fluid, respectively. In a particular embodiment, the first fluid is selected to deposit material onto the microfeature workpiece or remove material from the microfeature workpiece, and the second fluid is selected to rinse the microfeature workpiece after being processed by the first fluid.

The foregoing arrangement can be used to minimize or at least control the amount of wasted processing solutions. This arrangement can also be used to control, and in some cases prevent, mixing of the first and second fluids. For example, the second fluid can include water that is allowed to mix with the first fluid in limited quantities so as to avoid significantly diluting the first fluid. The first fluid can include an acid that is prevented from mixing with the second fluid so as to avoid contaminating the second fluid.

In other embodiments, the degree to which the first and second fluids mix within the processing chamber is controlled. For example, in some cases, the second fluid includes deionized water or another substance, e.g., a solvent or solute, that is a constituent of the first fluid. The deionized water may evaporate from the first fluid during processing, and by allowing some or all of the second fluid to mix with the first fluid after it is directed into the processing chamber, the evaporative loss of the deionized water from the first fluid can be compensated for by mixing in some or all of the second fluid.

### BRIEF DESCRIPTION OF THE DRAWINGS

FIG. 1 is a perspective view of a reactor constructed in accordance with an embodiment of the present invention.

FIG. 2 is a partially schematic, cross-sectional view of the reactor illustrated in FIG. 1.

FIG. 3 is a partially schematic, side elevation view of the reactor shown in FIG. 1, illustrating provisions for handling multiple captured fluids in accordance with an embodiment of the invention.

FIG. 4 illustrates a workpiece support configured to tilt a workpiece during fluid application, in accordance with another embodiment of the invention.

FIG. 5 illustrates a tool having one or more chambers configured in accordance with an embodiment of the invention.

### DETAILED DESCRIPTION

The following description discloses the details and features of several embodiments of processing stations, integrated tools, and associated methods for processing microfeature workpieces. The term “microfeature workpiece” is used throughout to include a workpiece formed from a substrate upon which. and/or in which, submicron or micron-scale (1-100 microns) circuits or components, and/or data storage elements or layers, are fabricated. Features in the substrate include, but are not limited to, trenches, vias, lines, and holes. These features typically have at least one small dimension (e.g., ranging from, for example, 0.1 micron to 100 micron) generally transverse to a major surface (e.g., a front side or a backside) of the workpiece. The term “microfeature workpieces” is also used to include substrates upon which, and/or in which, micromechanical features are formed. Such features include read/write head features and other micromechanical elements having submicron or supramicron dimensions. In any of these embodiments, the workpiece substrate is formed from suitable materials, including ceramics, and may support layers and/or other formations of other materials, including, but not limited to, metals, dielectric materials, semiconducting materials, and photoresists.

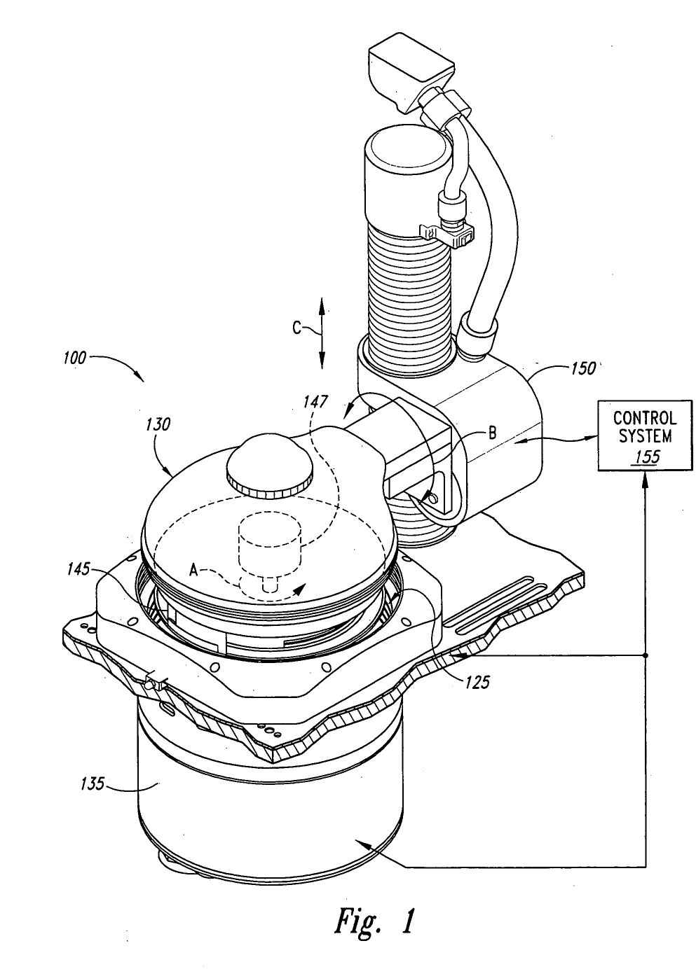

It will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the invention. Additionally, the invention can include other embodiments that are within the scope of the claims, but are not described in detail with respect to FIGS. 1-5.

FIG. 1 illustrates an apparatus or station 100 for processing a microfeature workpiece 125 (e.g., a semiconductor wafer) in accordance with an embodiment of the invention. The apparatus 100 includes a workpiece support or head 130 positioned to support the workpiece 125 during processing. The apparatus 100 also includes a reactor chamber or vessel 135 that receives one or more processing fluids from one or more fluid delivery systems. The workpiece support 130 carries the workpiece 125 in contact with the processing fluids to perform operations that include, but are not limited to, depositing material on the workpiece 125, removing material from the workpiece 125, and rinsing the workpiece 125.

The workpiece support 130 includes a rotor assembly 145 that is driven by a rotor motor 147. The rotor assembly 145 receives and carries the workpiece 125, supports the workpiece 125 in a process-side down orientation within the chamber 135, and spins the workpiece 125 during processing, as indicated by arrow A. The workpiece support 130 is mounted on a lift/rotate apparatus 150 that is configured to rotate the workpiece support 130 from an upwardly facing position in which it receives the workpiece 125, to a downwardly facing position in which the surface of the workpiece 125 faces downwardly for processing in the vessel 135, as indicated by arrow B. The lift/rotate apparatus 150 can also move the workpiece 125 to a plurality of axial positions relative to the chamber 135, as indicated by arrow C. For example, the lift/rotate apparatus 150 can move the workpiece support 130 and the corresponding workpiece 125 upwardly and downwardly toward and away from the chamber 135. The axial motion, rotational motion, and. spin motion of the workpiece support 130 may be directed by a programmable control system 155. Accordingly, the control system 155 may include computer-readable media that are programmed not only to control the motion of the workpiece support 130, but also to coordinate the motion of the workpiece support 130 with the application of fluids to the workpiece 125.

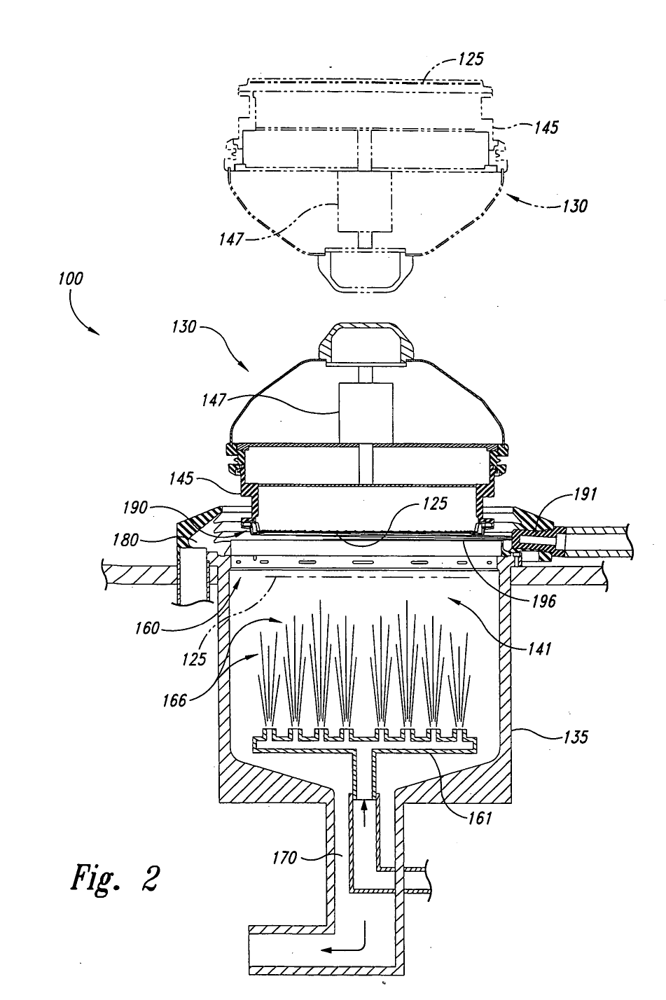

FIG. 2 is a partially schematic, cross-sectional side elevation view of an embodiment of the apparatus 100 described above with reference to FIG. 1. The workpiece support 130 is positioned above the processing chamber 135 and is inverted to receive a microfeature workpiece 125, as shown in phantom lines in FIG. 2. The workpiece support 130 then rotates to position the microfeature workpiece 125 to face downwardly, and then moves the microfeature workpiece 125 axially toward the processing chamber 135 for processing.

The processing chamber 135 includes a processing volume 141 having one or more processing positions, two of which are shown in FIG. 2 as a first processing position 160 and a second processing position 190. When the microfeature workpiece 125 is at the first processing position 160 (as shown in phantom lines), a first fluid delivery portion, device, system or other structure 161 delivers first unsupported stream(s) 166 of a first fluid to impinge on the microfeature workpiece 125. As used herein, the term “unsupported stream” is used to mean a free stream or jet of liquid that, for at least a portion of its length, is directed through a non-liquid and non-solid medium toward a target. The first unsupported stream(s) 166 can accordingly pass through a gas (e.g., air or an inert gas). The first processing fluid is collected at a first fluid collector 170, after contacting the microfeature workpiece 125.

When the microfeature workpiece 125 is in the second processing position 190 (as shown in solid lines), it can receive the first fluid, and/or a second fluid provided by a second fluid delivery portion, device, system or other structure 191. The second fluid delivery portion 191 directs a second unsupported stream 196 of the second fluid to impinge on the microfeature workpiece 125. The second fluid is collected in a second fluid collector 180 by spinning the microfeature workpiece 125 so as to sling the second fluid outwardly by centrifugal force. As described in greater detail below, the amount and type of fluid collected at the first fluid collector 170 and the second fluid collector 180 may be controlled in different manners, depending on the compositions of the first and second fluids and on the processes performed in the processing chamber 135.

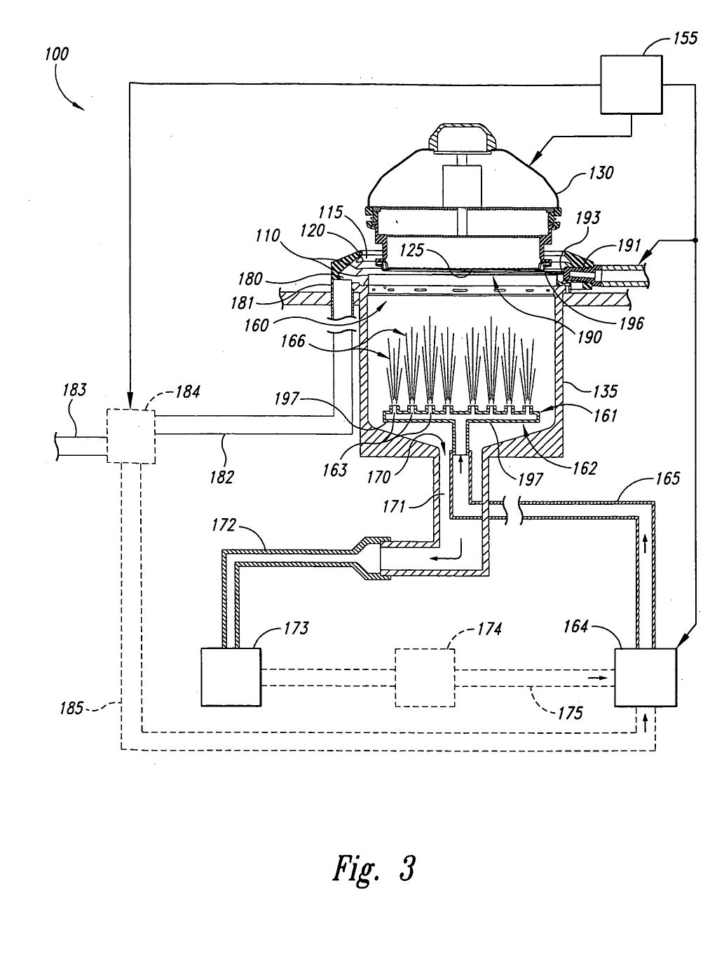

FIG. 3 illustrates further details of an arrangement for dispensing and collecting the first and second fluids, in accordance with an embodiment of the invention. The first fluid is provided to the first fluid delivery portion 161 by a supply line 165 coupled to a first fluid supply reservoir 164. The first fluid delivery portion 161 includes a manifold 162 having a plurality of first fluid orifices 163, each configured to direct one of the first fluid streams 166. The manifold 162 shown in FIG. 3 includes four crossarms 197 (two of which are visible in FIG. 3), each of which supports four first fluid orifices 163. In one embodiment, the crossarms 197 (and the first fluid orifices 163) rotate within the processing chamber 135, and in other embodiments the crossarms 197 (and the first fluid orifices 163) are stationary. In still other arrangements, the manifold 162 may include more or fewer crossarms 197, or the manifold may be eliminated, and the first fluid delivery portion 161 may include only a single first fluid orifice 163.

The first fluid collector 170 is positioned to collect the first fluid after the first fluid has impinged on the microfeature workpiece 125. The first fluid collector 170 accordingly includes a drain 171 coupled to a return line 172 that is in turn coupled to a first fluid return reservoir 173. The fluid collected in the first fluid return reservoir 173 may be discarded, or it may be returned to the first fluid supply reservoir 164 via a recycle line 175. If the first fluid is returned, a treatment unit 174 filters and/or otherwise treats the first fluid before it is returned to the first fluid supply reservoir 164.

The second fluid delivery portion 191 directs the second fluid through a second orifice 193 toward the microfeature workpiece 125. In one arrangement, the control system 155 directs the workpiece support 130 to a position where the stream 196 of the second fluid strikes the workpiece 125 toward its center as the workpiece 125 spins. The control system 155 then directs the workpiece support 130 to move the workpiece 125 axially upwardly so that the impinging stream 196 scans radially outwardly across the face of the workpiece 125 to “chase” residual fluid and/or particulates from the workpiece 125. The second fluid collector 180, which is disposed radially outwardly from the microfeature workpiece 125, collects the second fluid as it is flung radially outwardly from the microfeature workpiece 125.

The second fluid collector 180 includes one or more fluid collection channels 110 that are sized and positioned to receive fluid from the workpiece 125 when the workpiece 125 is at a range of axial positions. Each fluid collection channel 110 is formed by a splash wall 115 and a retainer wall 120 that is positioned slightly below the splash wall 115. Both walls 115, 120 may be inclined upwardly. As the second fluid is flung radially outwardly, it strikes the splash wall 115 and is prevented from falling back into the first processing portion 160 by the retainer wall 120. The channels 110 direct the second fluid to a drain 181, which is coupled to a return line 182. The second fluid received in the return line 182 is then discarded or recycled, as described in greater detail below.

In one embodiment of the apparatus 100 described above, the first and second fluids may have different compositions. By providing two separate fluid delivery portions (e.g., the first fluid delivery portion 161 and the second fluid delivery portion 191), the amount of fluid used by the apparatus 100 can be reduced when compared with existing arrangements. In particular, the separate delivery portions 161, 191 eliminate the need for purging a single delivery portion of one fluid prior to providing a second, different, fluid through the same delivery portion. For example, an electroless plating fluid may be directed to the microfeature workpiece 125 via the first fluid delivery portion 161, and a rinsing fluid (such as deionized water) may subsequently be directed to the microfeature workpiece 125 through the second fluid delivery portion 191, after an electroless plating process (or a portion of the electroless plating process) has been completed. By providing the rinsing fluid through a second fluid delivery portion 191 that is separate from the first fluid delivery portion 161, an embodiment of the apparatus 100 eliminates the need for (1) purging the electroless processing liquid from the first fluid delivery portion 161 and then (2) providing a rinsing fluid through the same first fluid delivery portion 161. Furthermore, by collecting the first and second fluids independently of each other, the first fluid can be captured, recycled and re-used without being contaminated by the second fluid (though as discussed in greater detail below, the fluids can alternatively be allowed to mix).

In other embodiments, the first fluid can include a solution other than an electroless solution, e.g., an etching solution or an activation solution. In any of these embodiments, keeping the first and second fluids separate, or at least controlling the extent to which they mix can significantly reduce the amount of wasted fluid. In a particular example, only 1 ml of the first fluid is lost while processing a 200 mm diameter microelectronic workpiece 125 in the apparatus 100 (prior to rinsing with the second fluid). By contrast, at least some existing single-wafer spray chambers lose 40-50 ml of the first fluid. The increased fluid loss associated with existing devices (which do not dispense and collect the first and second fluids separately) occurs when the first and second fluids are allowed to mix in an uncontrolled fashion. As a result, the first fluid becomes contaminated with the second fluid and must be discarded, rather than being recycled for use with a subsequent workpiece 125. Still further (in at least one embodiment), capturing the first and second fluids independently eliminates the need for rinsing the interior surfaces of the processing chamber 135 after applying the first fluid and before capturing or draining the second fluid. Rinsing is typically required in existing devices to prevent contaminating the second fluid with the first fluid or diluting the first fluid with the second fluid. Capturing the second fluid independently of the first fluid allows the user to reduce or eliminate the first fluid contaminants introduced into the second fluid, which in turn reduces or eliminates the first fluid contaminants introduced into the process waste stream.

In one method of operation, the first fluid and the second fluid are kept entirely separate or nearly entirely separate within the processing chamber 135. For example, the microfeature workpiece 125 is positioned axially beneath the second fluid collector 180 while the first fluid is directed at the microfeature workpiece 125. Accordingly, all or nearly all of the first fluid in the processing chamber 135 is collected by the first fluid collector 170. After the flow of the first fluid has been halted, the workpiece support 130 is elevated so that the second fluid (directed at the microfeature workpiece 125 via the second fluid delivery portion 191) is entirely collected by the second fluid collector 180. As a result, a first fluid circuit that includes the first fluid delivery portion 161 and the first fluid collector 170 is isolated from fluid communication with a second fluid circuit that includes the second fluid delivery portion 191 and the second fluid collector 180. This arrangement is suitable for situations in which it is undesirable for the first and second fluids to mix, or where the fluids may only be allowed to mix by a slight amount in their effluent streams. In a particular case, at least seventy-five, and up to one-hundred, percent of the residual first fluid may be recovered, reducing drag-out when compared with existing methods.

In other situations, the apparatus 100 may be configured to allow a controlled amount of mixing between the first and second fluids. This arrangement is suitable in instances for which the two fluids are compatible, for example, instances in which the second fluid is a constituent of the first fluid. One such instance occurs when the first fluid includes deionized water as a constituent and the second fluid is composed entirely of deionized water. The entire amount of the second fluid provided by the second fluid delivery portion 191 is permitted to mix with the first fluid, for example, to offset evaporation of the deionized water from the first fluid during processing. In this situation, the second fluid collector 180 is eliminated or coupled to the first fluid supply reservoir 164 so as to allow the entirety of the second fluid to mix with the first fluid.

The apparatus 100 may be configured to control the amount of second fluid that mixes with the first fluid. For example, the second fluid collector 180 may be configured to allow some of the second fluid to proceed through the drain 181, while the rest of the second fluid returns to.the processing chamber 135 and the first fluid collector 170. The control system 155 accordingly controls the axial position of the workpiece 125, and/or the spin speed of the workpiece 125, both of which determine whether fluid flung from the workpiece 125 is received by the second fluid collector 180 or the first fluid collector 170.

In a particular example, the workpiece 125 is axially aligned with the second fluid collector, but then is rotated at a relatively low rate to direct at least some of the fluid on the surface of the microfeature workpiece 125 to the first fluid collector 170. This fluid may include the first fluid and/or the second fluid. In one process, the microfeature workpiece 125 is rotated slowly enough that the first and/or second fluid on its surface falls away from the microfeature workpiece 125 directly to the bottom of the processing chamber 135 without striking the walls of the processing chamber 135. In another process, the first and/or second processing fluid is slung from the microfeature workpiece 125 as it rotates at a relatively low speed strikes the walls of the processing chamber 135 and flows down the walls to the first fluid collector 170.

The microfeature workpiece 125 may subsequently be rotated at a higher rate to sling additional fluid to the second fluid collector 180. This step may be completed after most or all of the residual first fluid on the microfeature workpiece 125 has been returned to the first fluid collector 170. The microfeature workpiece 125 may then be rotated for an additional period of time to dry it.

The process described above may be used to control the amount of second fluid that is permitted to mix with first fluid after striking the workpiece 125. This process may also be used to prevent mixing between the two fluids. In one particular example, the workpiece 125 is aligned with the second fluid collector 180 while the first fluid strikes it, and while it rotates slowly enough that the first fluid flung from it returns to the first fluid collector 170. Then, without being moved axially, the microfeature workpiece 125 can receive the second fluid and rotate at a higher rate to fling the second fluid toward the second fluid collector 180. At this point, the workpiece 125 may be moved axially to scan the stream 196 of second fluid across the workpiece surface.

An advantage of both foregoing arrangements is that keeping the workpiece 125 at the same axial location while switching between the first and second fluids allows the workpiece 125 to be rinsed immediately after processing is complete, and reduces the likelihood for unintended additional processing. Even when the workpiece 125 is moved axially after receiving the first fluid and before receiving the second fluid, this motion may be quick and continuous to reduce or eliminate unintended additional processing. As noted above, the chemical interaction between the microfeature workpiece 125 and the first processing fluid can proceed in a thermally, chemically, and/or electrically uncontrolled fashion when (a) the workpiece 125 is out of contact with the first fluid streams 166 and (b) the second fluid has not yet impinged on the workpiece 125 (an action that halts the chemical interaction). Accordingly, an advantage of the foregoing arrangement is that it reduces the time during which the microfeature workpiece 125 is subjected to an uncontrolled process. This is unlike some conventional methods in which the microfeature workpiece 125 rotates for an extended period of time in a thermally, chemically, and/or electrically uncontrolled manner (while slinging off the first fluid) before the second fluid impinges on the microfeature workpiece 125.

The rotation speed of the workpiece 125 may also be controlled when the workpiece is moved axially from one location to another. In a particular example, a microfeature workpiece 125 having a diameter of 300 mm rotates at a speed of from zero to 100 rpm while at the first processing portion 160, and rotates at a speed of from about 50 to about 70 rpm while at the second processing portion 190. In other embodiments, the microfeature workpiece 125 can be rotated at other rates at each processing portion, but in any of these embodiments, the change in rotation speed as the microfeature workpiece 125 moves from the first processing position 160 to the second processing portion 190 can be relatively small. As a result, the microfeature workpiece 125 quickly attains the appropriate rotation speed for receiving the second fluid, which allows the user to more precisely control where the second fluid goes after impinging on the workpiece 125.

In a particular example, the first fluid includes an acid or a base (for removing material from the microfeature workpiece 125), the second fluid includes deionized water, and the bulk of the second fluid is captured by the second fluid collector 180, for example, with approximately 0.3 ml to 5 ml of the second fluid returning to the processing chamber 135. The control system 155 directs the position and spin speed of the workpiece 125 to control the destination of the second fluid. The control system 155 may also control the operation of a valve unit 184 that allows or prevents mixing of the captured fluids. The valve unit 184 can direct excess fluid captured by the second fluid collector 180 through an auxiliary line 183 for disposal or recycling. When the second fluid is a constituent of the first fluid, the valve unit 184 may direct some of the second fluid to the first fluid supply reservoir 164 via a return line 185.

In a further particular example, the apparatus 100 includes a stainless steel processing chamber 135 (e.g., a spray acid or spray solvent chamber) in which material is chemically removed from the microfeature workpiece 125. For example, a hydroxylamine solvent (such as ACT935, available from Ashland Chemical of Columbus, Ohio, or EKC-265, available from EKC Technology of Danville, Calif.) is used to strip or otherwise remove material (such as a photoresist material or a post-etch polymeric residue) from the microfeature workpiece 125. The second fluid in this embodiment includes deionized water for rinsing the solvent from the microfeature workpiece 125 after processing. At least a portion of the deionized water can be returned to the processing chamber 135 or to the first fluid supply reservoir 164 to account for evaporative loss of deionized water from the first fluid, as described above.

In a different example, the first fluid includes an electroless deposition processing fluid and the second fluid includes deionized water for rinsing the microfeature workpiece 125 after electroless processing. In other embodiments, the apparatus 100 supports the use of other combinations of first and second fluids. For example, conductive material may be electrolytically deposited on the microfeature workpiece 125 by coupling the microfeature workpiece 125 to an electrical potential source having a first polarity (e.g., a cathode) while the first fluid is in fluid communication with a charged electrode (e.g., an anode) having the opposite polarity. The first fluid stream(s) 196 accordingly provide a continuous, uninterrupted electrical path between the anode and the microfeature workpiece 125.

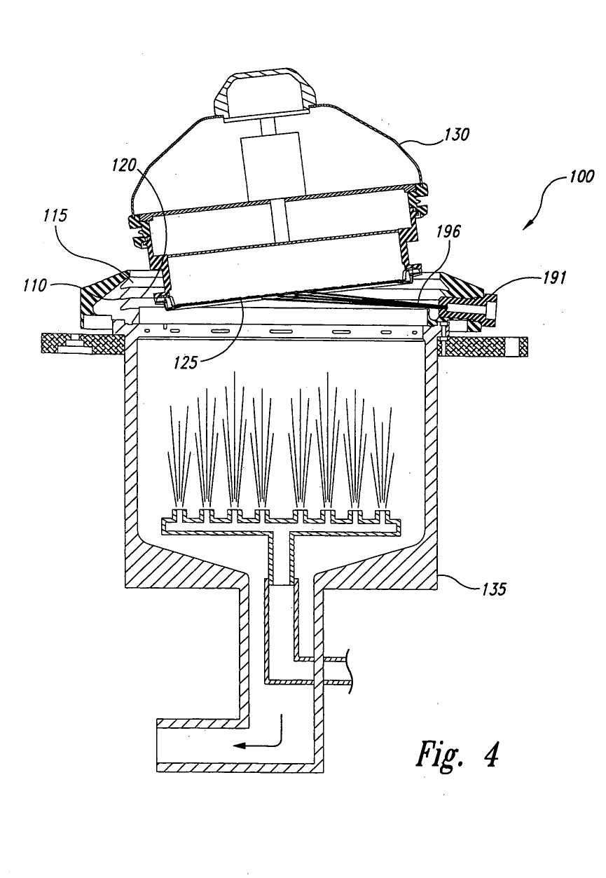

FIG. 4 is a partially schematic illustration of the apparatus 100, with the workpiece support 130 tilted during processing, in accordance with another embodiment of the invention. The workpiece support 130 can initially tilt to an angle at which the second fluid stream 196 intersects the central portion of the microfeature workpiece 125, while the microfeature workpiece 125 spins and slings the second fluid off. The tilt angle of the workpiece support 130 can be gradually reduced toward zero, which scans the second fluid stream 196 across the face of the microfeature workpiece 125, for example, during a rinsing process.

In other embodiments, apparatuses generally similar to those described above with reference to FIGS. 1-4 are used to perform other methods with one or more processing fluids. These methods can achieve several benefits, including reducing and/or controlling the amount of processing fluid removed from the processing chamber in effluent streams, or diluted in the processing chamber. In one arrangement, the first fluid and/or the second fluid are directed at portions of the apparatus 100 itself (e.g., for cleaning), in addition to or in lieu of directing the fluids at the microfeature workpiece 125. In a particular arrangement, the second fluid includes a solvent and/or deionized water, and the second fluid delivery portion 191 directs the second fluid to a contact ring, associated seal, or other portion of the workpiece support 130 to resist or prevent deposits from building up on these structures.

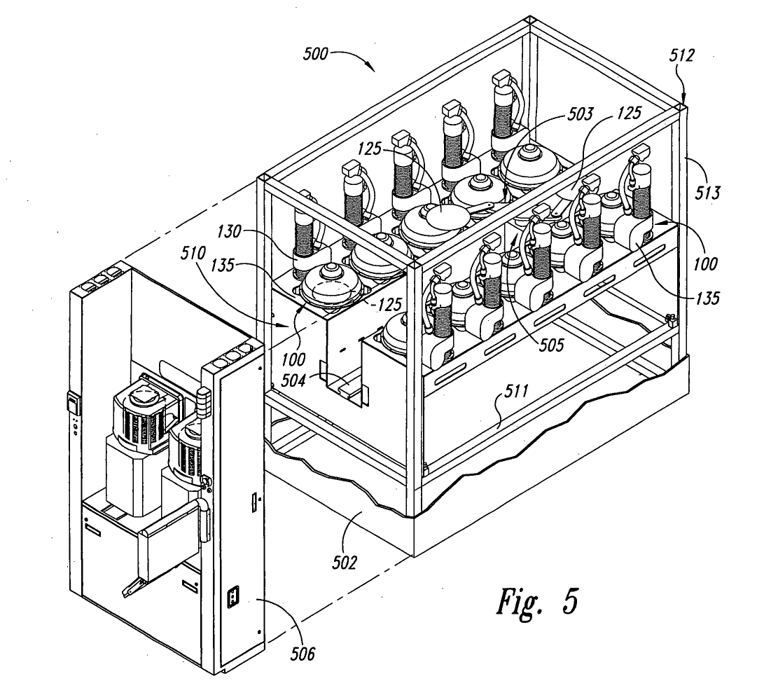

FIG. 5 schematically illustrates an integrated tool 500 that performs one or more wet chemical processes, including the processes described above with reference to FIGS. 1-4. The tool 500 includes a housing or cabinet 502 (shown broken away) that encloses a deck 514, a plurality of wet chemical processing stations 100, and a transport system 505. Each processing station 100 includes a vessel, chamber, or reactor 135 and a workpiece support (for example, a lift-rotate unit) 130 for transferring microfeature workpieces 125 into and out of the chamber 135. At least one of the stations 100 is generally similar to any of those described above with reference to FIG. 1-4, and other stations 100 may include cleaning chambers, etching chambers, electrochemical deposition chambers, or other types of wet chemical processing vessels. The transport system 505 moves the workpiece 125 among the stations 100, and includes a linear track 504 and a robot 503 that moves along the track 504. The integrated tool 500 further includes a workpiece load/unload unit 506 having a plurality of containers for holding the workpieces 125. In operation, the robot 503 transports workpieces 125 to/from the processing stations 101 within the tool 500, in accordance with a particular workflow schedule.

The integrated tool 500 includes a frame 512, and a dimensionally stable mounting module 510 mounted to the frame 512. The mounting module 510 carries the processing chambers 135, the workpiece supports 130, and the transport system 505.

The frame 512 has a plurality of posts 513 and cross-bars 511 that are welded together in a manner known in the art. A plurality of outer panels and doors (not shown in FIG. 5) are generally attached to the frame 512 to form the enclosed cabinet 502. The mounting module 510 is at least partially housed within the frame 512. In one embodiment, the mounting module 510 is carried by the cross-bars 511 of the frame 512, but the mounting module 510 can alternatively stand directly on the floor of the facility or other structures.

From the foregoing, it will be appreciated that specific embodiments of the invention have been described herein for purposes of illustration, but that various modifications may be made without deviating from the spirit and scope of the invention. For example, in many embodiments described above, a process fluid that actively changes the surface of the microfeature workpiece is directed from the first fluid delivery portion, and a rinse fluid is directed from the second fluid delivery portion positioned above the first fluid delivery portion. In other embodiments, the first fluid can be delivered from the second fluid delivery portion, and the second fluid can be delivered from the first fluid delivery portion. Aspects of the invention described in the context of particular embodiments may be combined and/or eliminated in other embodiments. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

1. An apparatus for processing microfeature workpieces, comprising:
a processing chamber;
a workpiece support positionable to support a workpiece in the processing chamber at a processing location;
a first fluid delivery device positioned to direct an unsupported stream of a first fluid into the processing chamber and against a workpiece located at the processing location;
a second fluid delivery device positioned to direct an unsupported stream of a second fluid into the processing chamber and against a workpiece located at the processing location;
a first fluid collector in fluid communication with the processing chamber; and
a second fluid collector in fluid communication with the processing chamber.

2. The apparatus of claim 1 wherein the first fluid collector includes a first drain and the second fluid collector includes a second drain positioned annularly outwardly from the first drain.

3. The apparatus of claim 1 wherein the first fluid delivery device is located below the processing location and the second fluid delivery device is located adjacent to the processing location.

4. The apparatus of claim 2 wherein the first fluid delivery device includes an array of spray nozzles, and wherein the second fluid delivery device includes a fluid orifice directed obliquely upwardly toward the processing location.

5. The apparatus of claim 1, further comprising a controller operatively coupled to the workpiece support and at least one of the fluid delivery devices, the controller being programmed to automatically move the workpiece support relative to the processing chamber while at least one of the unsupported streams is directed toward the microfeature workpiece.

6. The apparatus of claim 1 wherein the first fluid collector is isolated from fluid communication with the second fluid collector.

7. The apparatus of claim 1, further comprising at least one fluid collector line coupling the second fluid collector with the first fluid delivery device.

8. The apparatus of claim 1 wherein the workpiece support is configured to spin the workpiece about a first axis and tilt the workpiece about a second axis during processing.

9. The apparatus of claim 1 wherein:
the first fluid delivery device includes an array of spray nozzles located beneath the processing location;
the second fluid delivery device is positioned above the first fluid delivery device and includes a fluid orifice directed obliquely upwardly toward the processing location;
the workpiece support is movable axially relative to the processing location while the unsupported stream of the second fluid is directed against the workpiece to scan the unsupported stream of second fluid across the workpiece; and
the first fluid collector and the second fluid collector are positioned to separately collect the first fluid and the second fluid, respectively.

10. The apparatus of claim 1 wherein:
the first fluid delivery device includes an array of spray nozzles located beneath the processing location;
the second fluid delivery device is positioned above the first fluid delivery device and includes a fluid orifice directed obliquely upwardly toward the processing location;
the workpiece support is movable axially relative to the processing location while the unsupported stream of the second fluid is directed against the workpiece to scan the unsupported stream of second fluid across the workpiece;
the first fluid collector and the second fluid collector are positioned to separately collect the first fluid and the second fluid, respectively; and wherein the apparatus further comprises:
a control system coupled to the first fluid collector and the second fluid collector to control distribution of the fluids collected by the first and second fluid collectors, the control system including a controller operatively coupled to the workpiece support and at least one of the fluid delivery portions, the controller being programmed to automatically move the workpiece support relative to the processing volume while at least one of the unsupported streams is directed toward the microfeature workpiece.

11. A method for processing a microfeature workpiece, comprising:
positioning the microfeature workpiece at a processing location within a processing chamber;
directing an unsupported stream of a first fluid from a first fluid delivery device to the microfeature workpiece while the microfeature workpiece is at the processing location;
removing at least a portion of the first fluid from the processing chamber via a first fluid collector;
directing an unsupported stream of a second fluid from a second fluid delivery device to the microfeature workpiece while the microfeature workpiece is at the processing chamber, the second fluid being different than the first fluid; and
removing at least a portion of the second fluid from the processing chamber via a second fluid collector.

12. The method of claim 11 wherein removing at least a portion of the first fluid includes rotating the microfeature workpiece at a first rate about a rotation axis to sling the first fluid toward the first fluid collector, and wherein removing at least a portion of the second fluid includes rotating the microfeature workpiece about the rotation axis at a second rate greater than the first rate to sling the second fluid toward the second fluid collector, without moving the microfeature workpiece axially along the rotation axis.

13. The method of claim 11 wherein directing the first fluid includes directing at least one of an electrolytic processing fluid, an electroless processing liquid and an etchant, and wherein directing the second fluid includes directing a rinse fluid.

14. The method of claim 11 wherein directing the stream of the second fluid includes directing the stream of the second fluid after directing the stream of the first fluid and without first purging the first fluid delivery portion of the residual first fluid.

15. The method of claim 11, further comprising:
removing material from the microfeature workpiece by impinging the first fluid on the microfeature workpiece; and
rinsing the microfeature workpiece by impinging the second fluid on the microfeature workpiece.

16. The method of claim 11, further comprising controlling an amount of the second fluid that mixes with the first fluid in the processing chamber.

17. The method of claim 11, further comprising:
selecting the first fluid to include a mixture; and
selecting the second fluid to include a component of the first fluid.

18. The method of claim 11, further comprising at least restricting an amount of the second fluid that mixes with the first fluid in the processing chamber.

19. The method of claim 11, further comprising moving the microfeature workpiece relative to the processing chamber while at least one of the first and second fluids impinges on the microfeature workpiece.

20. The method of claim 11, further comprising rotating and translating the microfeature workpiece relative to the processing chamber while at least one of the first and second fluids impinges on the microfeature workpiece.

21. The method of claim 11, further comprising mixing at least a portion of the second fluid with the first fluid in the processing chamber.

22. The method of claim 11 wherein the second fluid includes water and wherein the method further comprises at least partially offsetting evaporation of the first fluid by mixing at least a portion of the second fluid with the first fluid in the processing chamber.

23. The method of claim 11, further comprising drying the microfeature workpiece after directing the second fluid to the microfeature workpiece.

24. The method of claim 11 wherein positioning the microfeature workpiece includes positioning the microfeature workpiece at a first location in the processing chamber while directing the first fluid and while collecting at least a portion of the first fluid, and wherein the method further comprises:
moving the microfeature workpiece from the first location to a second location aligned with the second fluid collector while directing the second fluid; and
rotating the microfeature workpiece while the microfeature workpiece is at the second location to direct at least a portion of at least one of the first and second fluids away from the microfeature workpiece and to the first fluid collector.

25. The method of claim 24 wherein rotating the microfeature workpiece includes rotating the microfeature workpiece at a first rate, and wherein the method further comprises rotating the microfeature workpiece at a second rate higher than the first rate to direct at least a portion of at least one of the first and second fluids away from the microfeature workpiece and to the second fluid collector of the processing station.

26. The method of claim 24, further comprising moving the microfeature workpiece from the first location to the second location in an at least approximately continuous manner.

27. The method of claim 11 wherein:
positioning the microfeature workpiece includes positioning the microfeature workpiece at a first location of the processing chamber;
directing an unsupported stream of a first fluid includes directing an unsupported stream of a first fluid from the first fluid delivery device to the microfeature workpiece while the microfeature workpiece is at the first location in the processing volume;
removing at least a portion of the first fluid includes removing at least a portion of the first fluid via a first drain; and wherein the method further comprises:
moving the microfeature workpiece from the first location to a second location of the processing chamber; and wherein
directing an unsupported stream of a second fluid includes directing an unsupported stream of a second fluid from the second fluid delivery device to the microfeature workpiece while the microfeature workpiece is at the second location;
removing at least a portion of the second fluid includes removing at least a portion of the second fluid from via a second drain; and wherein the method further comprises:
controlling an amount of the second fluid that mixes with the first fluid in the processing volume.
